(19) United States
(12) Patent Application Publication
(10) Pub. No.: US 2025/0208369 A1
(43) Pub. Date: Jun. 26, 2025

(54) LENS UNIT

(71) Applicant: NIDEC INSTRUMENTS CORPORATION, Nagano (JP)

(72) Inventor: Tomoaki NAKAJIMA, Nagano (JP)

(21) Appl. No.: 18/851,696

(22) PCT Filed: Mar. 15, 2023
(86) PCT No.: PCT/JP2023/009985

§ 371 Date: Sep. 27, 2024

(30) Foreign Application Priority Data
Mar. 31, 2022 (JP) 2022-058012

(51) Int. Cl. G02B 7/02; G02B 27/00; G03B 17/12; G03B 30/00

(52) U.S. Cl. CPC G02B 7/021; G02B 7/025; G02B 27/0006; G03B 17/12; G03B 30/00

(57) ABSTRACT

A lens unit includes a first barrel member holding a first lens, and a second barrel member holding a lens group. The first barrel member includes a first cylindrical portion including a holding portion holding the first lens from an outer peripheral side and an annular protrusion protruding from the first cylindrical portion to an inner peripheral side. The annular protrusion includes a first lens support portion supporting the first lens from an image side. The second barrel member includes a second cylindrical portion surrounding the lens group from the outer peripheral side and a flange portion protruding from the second cylindrical portion to the outer peripheral side. The second barrel member is positioned in a radial direction by the second cylindrical portion inserted into the inner peripheral side of the annular projection and is positioned in an optical axis direction by the flange portion abutting the annular projection.

### RELATED APPLICATIONS

The present application is National Phase of International Application Number PCT/JP2023/009985, filed Mar. 15, 2023, and claims priority based on Japanese Patent Application No. 2022-058012, filed Mar. 31, 2022.

### TECHNICAL FIELD

The present invention relates to a lens unit in which a lens barrel includes two lens barrel members.

### BACKGROUND ART

Patent Literature 1 discloses a lens unit used in an imaging apparatus mounted on an automobile or a surveillance camera. The lens unit in the literature includes a first lens located on the object side, a lens group located on the image side of a second lens, and a lens barrel that holds the first lens and the second lens. The lens barrel includes an annular inner frame member and an annular outer frame member surrounding the inner frame member from the outer periphery. The inner frame member includes a cylindrical portion and a flange portion that protrudes from an end portion of the cylindrical portion on the object side to the outer peripheral side. The outer frame member includes an annular step portion that supports the flange portion from the image side in a state where the inner frame member is penetrated. The lens group is accommodated on the inner peripheral side of the inner frame member. The first lens is held by the outer frame member from the outer peripheral side and is supported by the flange portion of the inner frame member from the image side.

### Citation List

### Patent Literature

Patent Literature 1:
Japanese Unexamined Patent Publication No. 2021-5019

### SUMMARY OF THE INVENTION

### Problems to be Solved by the Invention

When the above-described lens unit is assembled, the lens group is accommodated in the inner frame member, then the inner frame member is supported by the annular step portion of the outer frame member, and then the first lens is engaged with the flange portion of the inner frame member while being held by the outer frame member. Therefore, in the manufacturing step of the lens unit, the step of holding the first lens in the outer frame member cannot be performed until the step of holding the lens group in the inner frame member is completed.

In view of the above problem, it is an object of the present invention to provide a lens unit in which a step of holding a first lens in a lens barrel and a step of holding a lens group located on the image side of the first lens in the lens barrel can be performed separately and independently.

### Means for Solving the Problem

In order to solve the above problem, a lens unit according to the present invention includes a first lens barrel member that holds a first lens and a second lens barrel member that holds, on an inner peripheral side of the first lens barrel member, a lens group located on an image side of the first lens, and the first lens barrel member includes a first cylindrical portion including a holding portion that holds the first lens from an outer peripheral side and an annular protrusion that protrudes from the image side of the holding portion to an inner peripheral side in the first cylindrical portion, the second lens barrel member includes a second cylindrical portion that surrounds the lens group from an outer peripheral side and a flange portion that protrudes from the second cylindrical portion to an outer peripheral side, and is separated from the first lens to the image side, the annular protrusion includes a first lens support portion that includes an annular support surface that supports the first lens from the image side, a radial direction positioning portion that is in contact with the second cylindrical portion from an outer side in a radial direction and positions the second lens barrel member in the radial direction, and an optical axis direction positioning portion that is in contact with the flange portion from an object side and positions the second cylindrical portion in an optical axis direction, and the flange portion is fixed to the annular protrusion.

According to the present invention, the first lens is held by the first lens barrel member, and the lens group located on the image side of the first lens is held by the second lens barrel member. In addition, the second lens barrel member that holds the lens group located on the image side of the first lens is separated from the first lens to the image side. Therefore, the second lens barrel member is not involved in holding the first lens. Therefore, when the lens unit is manufactured, holding the first lens in the first lens barrel member and holding the lens group in the second lens barrel member can be performed separately and independently. Here, in a case where holding the first lens in the first lens barrel member and holding the lens group in the second lens barrel member can be performed separately, when a plurality of variations having different shapes of the first lens barrel member is developed as the lens unit, the first unit including the first lens and the second lens barrel member holding the first lens can be manufactured for each variation, and the second unit including the lens group and the second lens barrel member holding the lens group can be manufactured as a common component which is not influenced by the variation. In this way, it is possible to flexibly cope with a case where the mass production quantity for each variation of the lens unit is changed. Further, the annular protrusion of the first lens barrel member includes the radial direction positioning portion that positions the second cylindrical portion in the radial direction and the optical axis direction positioning portion that positions the second cylindrical portion in the optical axis direction. Therefore, the second lens barrel member is fixed to the first lens barrel member with high positional accuracy. Therefore, even when the lens barrel includes two members, it is possible to prevent or suppress a decrease in the positional accuracy between the first lens and the lens group.

According to the present invention, the second lens barrel member may include an abutting portion that is bent from an end of the second cylindrical portion on the object side to an inner peripheral side and abuts a second lens located closest to the object side in the lens group from the object side, and an annular support portion that protrudes to an inner side in a radial direction from the second cylindrical portion and supports the lens group from the image side. In this case, the abutting portion can be provided by caulking the end portion of the second cylindrical portion.

Further, according to the present invention, an annular retainer attached to an end portion of the second cylindrical portion on the object side may be included, and the retainer may include a peripheral wall portion fixed to an outer peripheral side of the end portion of the second cylindrical portion on the object side and an abutting portion that extends from an end of the peripheral wall portion on the object side to an inner peripheral side and abuts a second lens located closest to the object side in the lens group from the object side, and the second lens barrel member may include an annular support portion that protrudes to an inner side in a radial direction from the second cylindrical portion and supports the lens group from the image side.

According to the present invention, the flange portion may protrude from a middle of the second cylindrical portion in the optical axis direction, an inner-peripheral side end surface of the annular protrusion may be provided with a plurality of projections arranged in a circumferential direction, the plurality of projections may be in contact with an object-side cylindrical portion located closer to the object side than the flange portion in the second cylindrical portion from an outer side in the radial direction, and the plurality of projections may be the radial direction positioning portion. In this manner, the second cylindrical portion of the second lens barrel member is press-fitted into the inner side of the annular protrusion of the first lens barrel member so that the second lens barrel member can be positioned in the radial direction with respect to the first lens barrel member. In addition, in a case where the plurality of projections arranged in the circumferential direction is provided on the inner-peripheral side end surface of the annular protrusion, when the second cylindrical portion of the second lens barrel member is press-fitted into the inner side of the annular protrusion of the first lens barrel member, a gap is formed between the projections in the circumferential direction. Therefore, the air between the first lens barrel member holding the first lens and the second lens barrel member holding the lens group can be released through the gap. Therefore, it is easy to press-fit the second lens barrel member holding the lens group to the inner side of the annular protrusion of the first lens barrel member.

According to the present invention, the plurality of projections may be provided on the object side of the inner-peripheral side end surface, the lens group may include a lens located on an inner side of the object-side cylindrical portion in the radial direction, the lens may include, in the stated order from the object side to the image side, a contact portion with which the object-side cylindrical portion is in contact from an outer side in the radial direction and a facing portion that faces the object-side cylindrical portion with a gap therebetween in the radial direction, and when viewed from a direction orthogonal to the optical axis, the plurality of projections and the facing portion of the lens may overlap each other. In this manner, when the object-side cylindrical portion of the second cylindrical portion is press-fitted into the inner side of the annular protrusion of the first lens barrel member, it is possible to prevent or suppress the stress generated in the second cylindrical portion from being transmitted to the lens located on the inner side of the object-side cylindrical portion in the radial direction. Therefore, it is possible to prevent or suppress the occurrence of distortion in the lens.

According to the present invention, the annular protrusion may include an annular groove recessed to the image side on an outer peripheral side of the support surface, an annular elastic member may be inserted into the annular groove, and the elastic member may seal a space between the first lens and the annular protrusion in a state of being compressed in the optical axis direction. In this manner, it is possible to prevent water or the like from entering the space between the first lens and the second lens from the object side of the first lens barrel member.

According to the present invention, the first lens barrel member and the second lens barrel member may be made of resin, and the annular protrusion and the flange portion may be welded to each other.

According to the present invention, in a state before the annular protrusion and the flange portion are welded to each other, the annular protrusion may include, on a surface facing the image side, a first reference surface perpendicular to the optical axis and a first welding surface parallel to the first reference surface and provided at a position shifted from the first reference surface to an image side X1, the flange portion may include, on a surface facing the object side, a second reference surface perpendicular to the optical axis and a second welding surface parallel to the second reference surface and provided at a position shifted from the second reference surface to the other side in the optical axis direction, one of the first welding surface and the second welding surface may be provided with a welding substitute projection that projects in the optical axis direction, in a state where the annular protrusion and the flange portion are welded to each other, the first reference surface and the second reference surface may be in surface contact with each other, and the first welding surface and the second welding surface may be welded to each other. In this manner, since the first reference surface of the annular protrusion is the optical axis direction positioning portion, it is possible to increase the positional accuracy of the second lens barrel member with respect to the first lens barrel member when the flange portion is fixed to the annular protrusion.

According to the present invention, the first lens barrel member may be made of crystalline resin, and the second lens barrel member may be made of amorphous resin. In this manner, it is possible to increase the weather resistance of the first lens barrel member compared to a case where the first lens barrel member is made of amorphous resin. Therefore, when the lens unit is mounted on an in-vehicle imaging apparatus or an imaging apparatus installed outdoors, it is possible to suppress aged deterioration of the first lens barrel member. In addition, in this manner, the water absorbability of the second lens barrel member is improved compared to a case where the second lens barrel member is made of crystalline resin. Here, in a case where the second lens barrel member has high water absorbability, when moisture is present in the space located closer to the image side than the first lens on the inner peripheral side of the first lens barrel member, the moisture can be absorbed by the second lens barrel member. Therefore, it is possible to prevent or suppress fogging of the image-side surface of the first lens and each lens constituting the lens group.

### Effect of the Invention

According to the present invention, the first lens is held from the outer peripheral side by the holding portion of the first cylindrical portion of the first lens barrel member and is held from the object side by the annular protrusion of the first lens barrel member. In addition, the second lens barrel member that holds the lens group located on the image side of the first lens is separated from the first lens to the image side. Therefore, the second lens barrel member is not involved in holding the first lens. Therefore, when the lens unit is manufactured, holding the first lens in the first lens barrel member and holding the lens group in the second lens barrel member can be performed separately and independently.

### BRIEF DESCRIPTION OF THE DRAWINGS

FIG. 1 is an external perspective view of a lens unit to which the present invention is applied.

FIG. 2 is a cross-sectional view taken along the line A-A in FIG. 1.

FIG. 3 is an exploded perspective view of the lens unit.

FIG. 4 is a perspective view of a first lens barrel member as viewed from an image side.

FIG. 5 is a perspective view of a second lens barrel member as viewed from the image side.

FIG. 6 is an explanatory diagram of a state in which the second lens barrel member is press-fitted into the first lens barrel member.

FIG. 7 is a perspective view of a second lens barrel member in a case where a flange portion includes a through-hole.

FIG. 8 is a perspective view of a second lens barrel member in a case where a support portion includes a through-hole.

FIG. 9 is an explanatory diagram of a case where a retainer is attached to a second lens barrel member.

### MODE FOR CARRYING OUT THE INVENTION

An embodiment of a lens unit to which the present invention is applied will be described below with reference to the drawings.

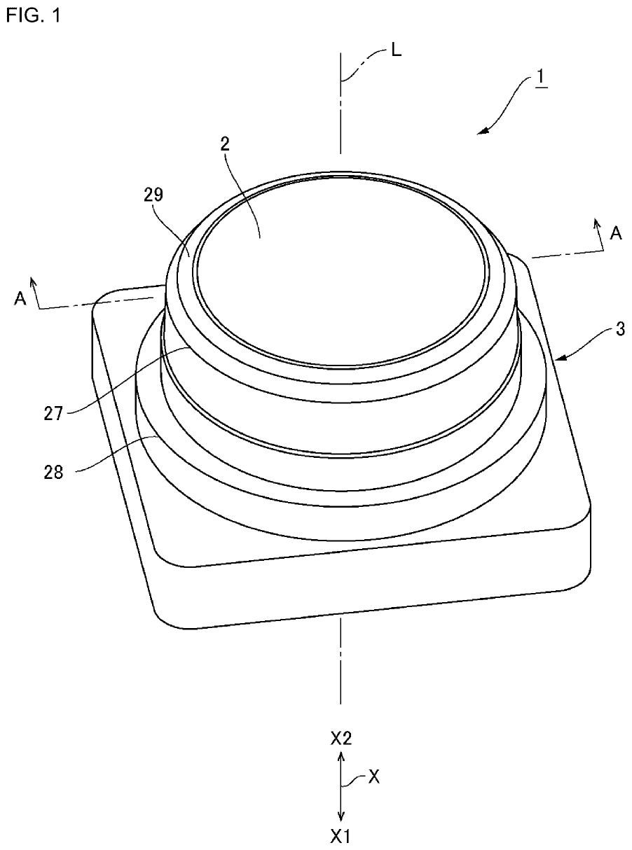

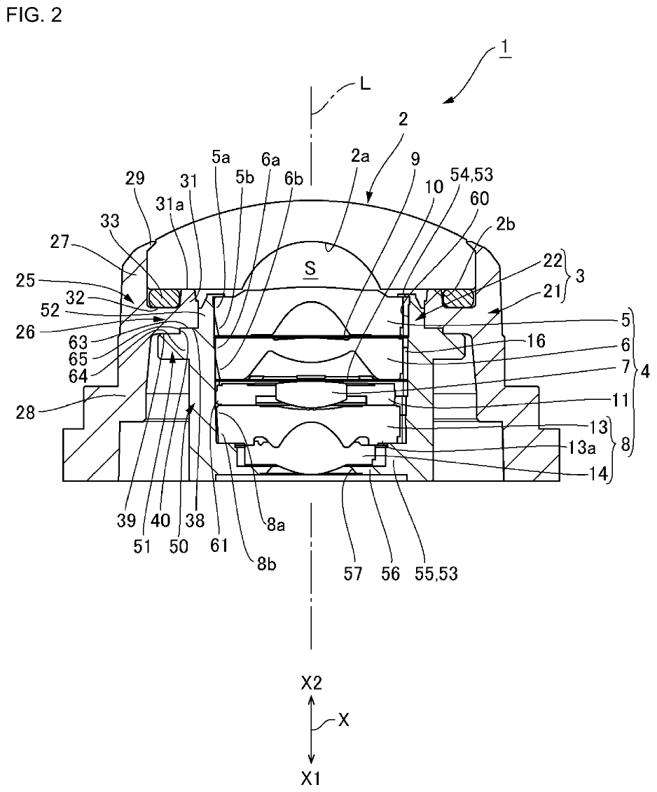

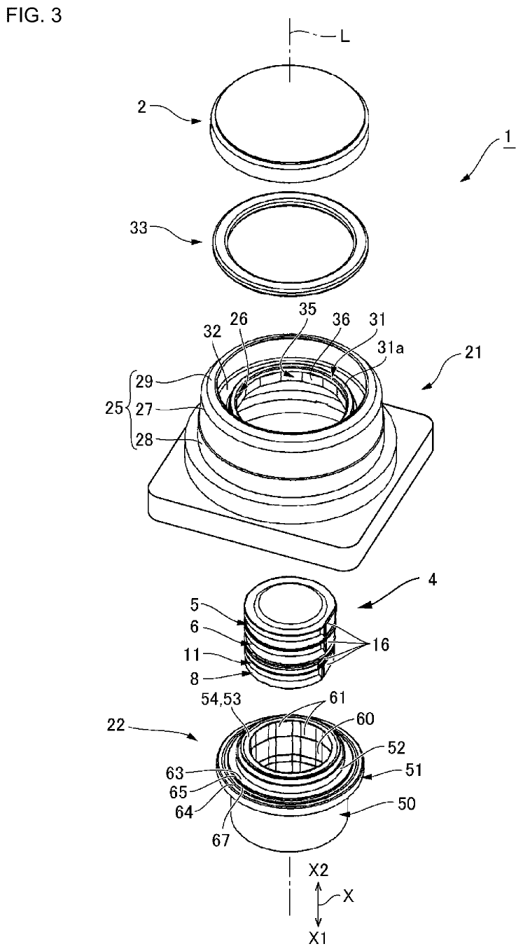

FIG. 1 is an external perspective view of a lens unit to which the present invention is applied. FIG. 2 is a cross-sectional view of the lens unit taken along the line A-A in FIG. 1. FIG. 3 is an exploded perspective view of the lens unit. A lens unit 1 according to the present embodiment is used in an imaging apparatus mounted on an automobile or a surveillance camera.

### Optical System

As illustrated in FIG. 1, the lens unit 1 includes a first lens 2 and a lens barrel 3. Further, as illustrated in FIG. 2, the lens unit 1 includes a lens group 4 held by the lens barrel 3 on an image side X1 of the first lens 2 in an optical axis direction X along an optical axis L of the first lens 2. The lens group 4 includes a second lens 5, a third lens 6, a fourth lens 7, and a fifth lens 8 from an object side X2 to the image side X1 in the optical axis direction X. The fifth lens 8 is a cemented lens in which two lenses are cemented. Each of the lenses 5 to 8 constituting the lens group 4 has an outer diameter size smaller than that of the first lens 2. Further, the lens unit further includes an annular light shielding sheet 9 provided between the second lens 5 and the third lens 6, and an annular diaphragm 10 provided between the third lens 6 and the fourth lens 7.

The first lens 2 is made of resin or glass. The first lens 2 is a meniscus lens. The first lens 2 has, on the object side X2, a curved surface protruding to the object side X2. In addition, the first lens 2 includes, on the image side X1, a curved surface 2a that is recessed to the object side X2 and an annular flange surface 2b that extends in a direction orthogonal to the optical axis L on the outer peripheral side of the curved surface 2a. Black ink for light shielding is applied to the flange surface 2b.

The second lens 5 is made of resin. The second lens 5 is a meniscus lens. The second lens 5 includes, on the object side X2, a curved surface protruding to the object side X2 and, on the image side X1, a curved surface recessed to the object side X2. The second lens 5 includes, in the stated order from one side to the other side in the optical axis direction X, an object-side lens portion 5a whose outer peripheral surface extends parallel to the optical axis L and an image-side lens portion 5b whose outer peripheral surface is inclined to the inner peripheral side toward the image side X1.

The third lens 6 is made of resin. The third lens 6 has, on the object side X2, a curved surface to the object side X2 and, on the image side X1, a curved surface protruding to the image side X1. The third lens 6 includes, in the stated order from one side to the other side in the optical axis direction X, an object-side lens portion 6a whose outer peripheral surface extends parallel to the optical axis L and an image-side lens portion 6b whose outer peripheral surface is inclined to the inner peripheral side to the image side X1.

The fourth lens 7 is made of glass. The fourth lens 7 has an outer diameter size smaller than those of the second lens 5, the third lens 6, and the fifth lens 8. The fourth lens 7 is located between the third lens 6 and the fifth lens 8 while being held by an annular holder 11.

The fifth lens 8 includes an object-side lens 13 and an image-side lens 14 located on the image side X1 of the object-side lens 13. Both the object-side lens 13 and the image-side lens 14 are made of resin. The object-side lens 13 has, on the object side X2, a curved surface that is curved to the image side X1 and, on the image side X1, a curved surface recessed to the object side X2. Further, the object-side lens 13 includes, in the stated order from one side to the other side in the optical axis direction X, an object-side lens portion 8a whose outer peripheral surface extends parallel to the optical axis L and an image-side lens portion 8b whose outer peripheral surface is inclined to the inner peripheral side toward the image side X1. The image-side lens 14 has, on the object side X2, a curved surface protruding to the object side X2 and, on the image side X1, a curved surface protruding to the image side X1. The image-side lens 14 is cemented to the object-side lens 13 in a state where the curved surface protruding to the object side X2 is inserted into the curved surface recessed to the object side X2 of the object-side lens 13. The outer diameter size of the object-side lens 13 is larger than the outer diameter size of the image-side lens 14. Therefore, the object-side lens 13 includes an annular flange portion 13a located on the outer peripheral side of the image-side lens 14 when viewed from the optical axis direction X.

Here, the outer diameter size of the second lens 5, the outer diameter size of the third lens 6, the outer diameter size of the holder 11 that holds the fourth lens 7, and the outer diameter size of the fifth lens 8 are slightly shorter in the stated order. In addition, as illustrated in FIG. 3, the second lens 5, the third lens 6, the fourth lens 7, the fifth lens 8, and the holder 11 include, at a part in the circumferential direction, a cutout portion 16 that extends linearly in the circumferential direction when viewed from the optical axis direction X. The second lens 5, the third lens 6, the holder 11 that holds the fourth lens 7, and the fifth lens 8 are stacked in a state where the cutout portions 16 are located at the same angular position around the optical axis L.

### Lens Barrel

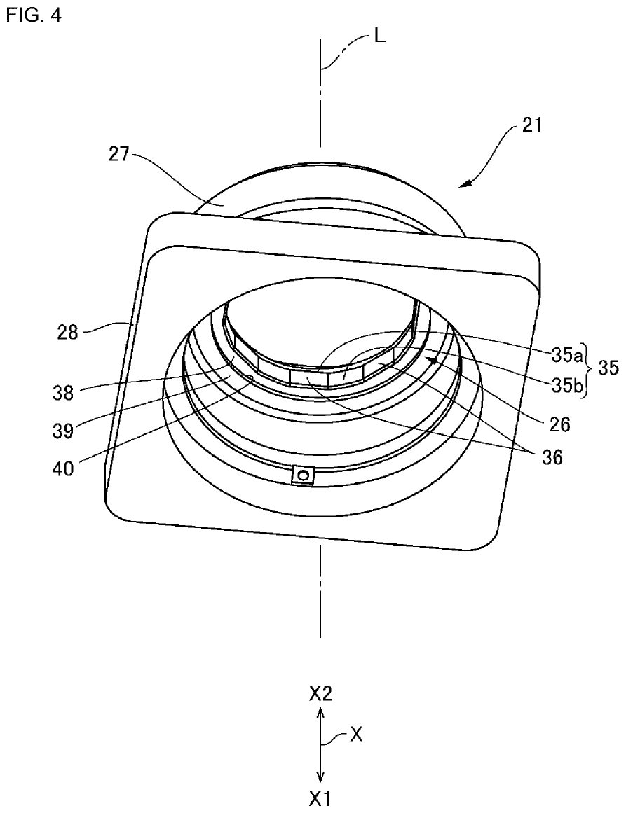

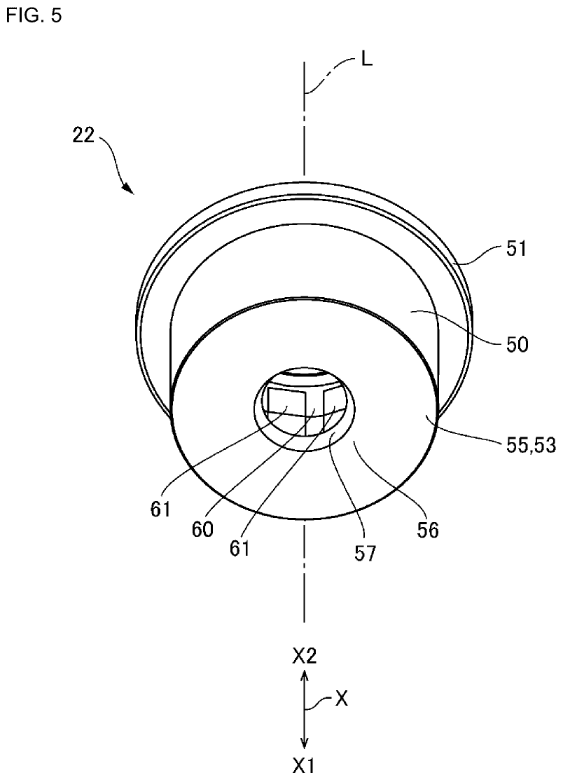

FIG. 4 is a perspective view of a first lens barrel member as viewed from the image side X1. FIG. 5 is a perspective view of a second lens barrel member as viewed from the object side X2. As illustrated in FIGS. 2 and 3, the lens barrel 3 includes two members, i.e., a first lens barrel member 21 that holds the first lens 2 and a second lens barrel member 22 that holds the lens group 4. As illustrated in FIG. 2, the second lens barrel member 22 is accommodated on the inner peripheral side of the first lens barrel member 21.

The first lens barrel member 21 is made of crystalline resin. The second lens barrel member 22 is made of amorphous resin. In this example, the first lens barrel member 21 is made of polyamide resin. The second lens barrel member 22 is made of polycarbonate. The first lens barrel member 21 and the second lens barrel member 22 are fixed to each other by welding.

### First Lens Barrel Member

As illustrated in FIGS. 2, 3, and 4, the first lens barrel member 21 includes a first cylindrical portion 25 located on the outer peripheral side of the first lens 2 and an annular protrusion 26 that protrudes to the inner side in the radial direction from the middle of the first cylindrical portion 25 in the optical axis direction X. As illustrated in FIGS. 2 and 3, the first cylindrical portion 25 includes, on the object side X2 of the annular protrusion 26, a holding portion 27 that holds the first lens 2 from the outer peripheral side. In addition, the first cylindrical portion 25 includes a skirt portion 28 on the image side X1 of the annular protrusion 26. Further, the first cylindrical portion 25 includes, at the end of the object side X2, a first abutting portion 29 that is bent to the inner peripheral side and abuts the first lens 2 from the object side X2.

As illustrated in FIGS. 2 and 3, the annular protrusion 26 has, on its surface facing the object side X2, a first lens support portion 31 including an annular support surface 31a that supports the first lens 2 from the image side X1. Further, the annular protrusion 26 includes, on the outer peripheral side of the support surface 31a, an annular groove 32 recessed to the image side X1. An annular elastic member 33 is inserted into the annular groove 32. The elastic member 33 is an O-ring.

A plurality of projections 36 is provided on an inner-peripheral side end surface 35 of the annular protrusion 26 facing the inner side in the radial direction. The plurality of projections 36 is arranged in the circumferential direction. In this example, the plurality of projections 36 is provided in a portion of the inner-peripheral side end surface 35 on the image side X1. Therefore, as illustrated in FIG. 4, the inner-peripheral side end surface 35 of the annular protrusion 26 facing the inner side in the radial direction includes, from the object side X2 toward the image side X1, an annular surface portion 35a that does not include the plurality of projections 36 and an annular uneven surface portion 35b that includes the plurality of projections 36.

The surface of the annular protrusion 26 facing the image side X1 includes a first reference surface 38 perpendicular to the optical axis L and a first welding surface 39 parallel to the first reference surface 38 and provided at a position shifted from the first reference surface 38 to the image side X1. The first welding surface 39 is located on the outer peripheral side of the first reference surface 38. A first annular surface 40 facing the inner side in the radial direction is provided between the first reference surface 38 and the first welding surface in the radial direction.

### Second Lens Barrel Member

As illustrated in FIGS. 2, 3, and 5, the second lens barrel member 22 includes a second cylindrical portion 50 that surrounds the lens group 4 from the outer peripheral side and a flange portion 51 that protrudes from the second cylindrical portion 50 to the outer peripheral side. The flange portion 51 protrudes to the outer side in the radial direction from a portion of the second cylindrical portion 50 on the object side X2. Therefore, the second cylindrical portion 50 includes an annular object-side cylindrical portion 52 located closer to the object side than the flange portion 51.

Further, the second lens barrel member 22 has a holding mechanism 53 that holds the lens group 4 from both sides in the optical axis direction X. The holding mechanism 53 includes a second abutting portion 54 (abutting portion) that is bent to the inner side in the radial direction from an end of the second cylindrical portion 50 on the object side X2 and abuts the second lens 5 from the object side X2 and an annular support portion 55 that protrudes to the inner side in the radial direction from a portion of the second cylindrical portion 50 on the image side X1 and supports the lens group 4. The support portion 55 abuts the flange portion 13a of the object-side lens 13 in the fifth lens 8 from the image side X1 and supports the lens group 4 from the image side X1. The support portion 55 includes, at an end portion on the object side X2, an annular plate portion 56 protruding to the inner side in the radial direction. An edge of the annular plate portion 56 on the inner peripheral side defines a circular opening 57. An imaging device (not illustrated) is fixed to the surface of the annular plate portion 56 on the image side X1 so as to close the circular opening 57.

As illustrated in FIG. 2, the support portion 55 and the annular plate portion 56 are not in contact with the image-side lens 14 of the fifth lens 8. That is, the support portion 55 faces the image-side lens 14 with a gap therebetween in the radial direction. The annular plate portion 56 faces the image-side lens 14 with a gap therebetween in the optical axis direction X.

An inner peripheral surface 60 of the second cylindrical portion 50 is slightly inclined to the inner peripheral side toward the image side X1. As illustrated in FIGS. 3 and 5, a plurality of ribs 61 extending in the optical axis direction X along the inner peripheral surface 60 is provided between the second abutting portion 54 and the support portion 55 on the inner peripheral surface 60 of the second cylindrical portion 50. The ribs 61 are arranged in the circumferential direction. As illustrated in FIG. 2, when the lens group 4 is accommodated in the second cylindrical portion 50, the ribs 61 abut the object-side lens portion 5a of the second lens 5, the object-side lens portion 6a of the third lens 6, the holder 11 holding the fourth lens 7, and the object-side lens portion 8a of the object-side lens 13 of the fifth lens 8 from the outer side in the radial direction to position the lens group 4 in the radial direction.

Here, the gap extending in the optical axis direction X is formed between the second cylindrical portion 50 and the second lens 5, the third lens 6, the holder 11 holding the fourth lens 7, and the fifth lens 8 by the cutout portion 16 provided therein. In addition, the gap extending in the optical axis direction X is formed between the second cylindrical portion 50, i.e., the ribs 61 adjacent to each other in the circumferential direction, and the second lens 5, the third lens 6, the holder 11 holding the fourth lens 7, and the fifth lens 8.

As illustrated in FIGS. 2 and 3, the flange portion 51 includes, on the surface facing the object side X2 from the inner peripheral side toward the outer peripheral side, a second reference surface 63 perpendicular to the optical axis L and a second welding surface 64 parallel to the second reference surface 63 and provided at a position shifted from the second reference surface 63 to the image side X1. Further, the annular protrusion 26 includes a second annular surface 65 facing the outer side in the radial direction between the second reference surface 63 and the second welding surface in the radial direction. Further, as illustrated in FIG. 3, in a state before the second lens barrel member 22 is fixed to the first lens barrel member 21, the flange portion 51 includes, on the second welding surface 64, a welding substitute projection 67 projecting to the object side X2. The welding substitute projection 67 extends in a circular arc in the circumferential direction.

### Assembly of Lens Unit

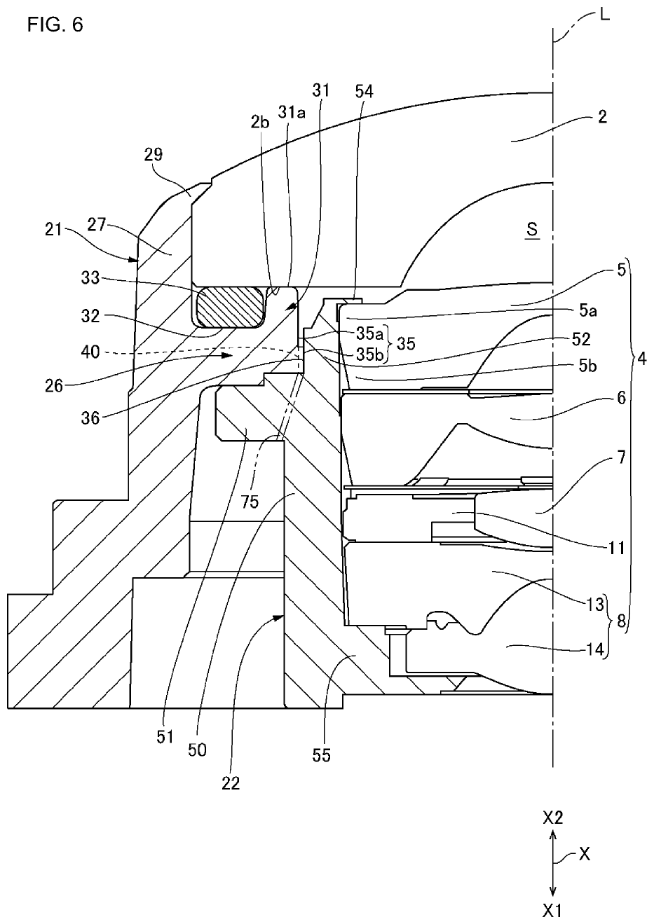

FIG. 6 is an explanatory diagram of a state in which the second lens barrel member 22 is press-fitted into the first lens barrel member 21. When the lens unit 1 is assembled, a first unit assembling operation of holding the first lens 2 in the first lens barrel member 21 and a second unit assembling operation of holding the lens group 4 in the second lens barrel member 22 are separately and independently performed. Then, a fixing operation of fixing the first unit whose assembly is completed and the second unit whose assembly is completed is performed.

During the first unit assembling operation, the elastic member 33 is inserted into the annular groove 32 of the first lens barrel member 21. Then, the first lens 2 is inserted into the inner peripheral side of the holding portion 27 of the first lens barrel member 21 from the object side X2, and the flange surface 2b abuts the support surface 31a of the first lens support portion 31 of the annular protrusion 26. Then, the end of the first lens barrel member 21 on the object side X2 is caulked to form the first abutting portion 29. Accordingly, the first lens 2 is held in the optical axis direction X by the first abutting portion 29 and the support surface 31a of the first lens support portion 31. In a state where the first lens 2 is held by the first lens barrel member 21, the elastic member 33 is compressed in the optical axis direction X. The elastic member 33 seals a space between the first lens 2 and the annular protrusion 26.

During the second unit assembling operation, the lens group 4 is accommodated in the second lens barrel member 22 from the object side X2, and the lens group 4 is supported by the support portion 55. Then, the end of the second lens barrel member 22 on the object side X2 is caulked to form the second abutting portion 54. Accordingly, the lens group 4 is held by the holding mechanism 53 from both sides in the optical axis direction X. When the lens group 4 is held by the second lens barrel member 22, the second lens 5 is located on the inner side in the radial direction of the object-side cylindrical portion 52 closer to the object side X2 than the flange portion 51 of the second cylindrical portion 50.

Then, the fixing operation for fixing the second unit to the first unit is performed. During the fixing operation, first, the second lens barrel member 22 holding the lens group 4 is inserted into the skirt portion 28. Then, the object-side cylindrical portion 52 of the second cylindrical portion 50 closer to the object side X2 than the flange portion 51 is press-fitted into the annular protrusion 26 of the first lens barrel member 21.

Here, as illustrated in FIG. 6, when the object-side cylindrical portion 52 is press-fitted, the plurality of projections 36 provided on the inner-peripheral side end surface 35 facing the inner side in the radial direction in the annular protrusion 26 of the first lens barrel member 21 abuts the outer peripheral surface of the object-side cylindrical portion 52 from the outer side in the radial direction to position the second annular cylindrical portion in the radial direction. That is, the plurality of projections 36 of the first lens barrel member 21 is a radial direction positioning portion that positions the second lens barrel member 22 in the radial direction. In addition, in this example, since the plurality of projections 36 is provided on the inner-peripheral side end surface 35 facing the inner side in the radial direction in the annular protrusion 26, when the second cylindrical portion 50 of the second lens barrel member 22 is press-fitted into the inner side of the annular protrusion 26 of the first lens barrel member 21, a gap 60 is formed between the projections 36 in the circumferential direction. Therefore, when the second lens barrel member 22 is press-fitted into the first lens barrel member 21, the air between the first lens barrel member 21 holding the first lens 2 and the second lens barrel member 22 holding the lens group 4 can be released to the outside through the gap 40. Therefore, it is easy to press-fit the second cylindrical portion 50 holding the lens group 4 into the inside of the annular protrusion 26 of the first lens barrel member 21.

As can be seen from FIG. 6, when viewed from the direction orthogonal to the optical axis L, the plurality of projections 36 and the image-side lens portion 5b of the second lens 5 overlap each other. Here, the image-side lens portion 5b of the second lens 5 faces the second cylindrical portion 50 with a gap therebetween. That is, the second lens 5 includes, in the stated order from the object side X2 toward the image side X1, the object-side lens portion 5a (contact portion) with which the object-side cylindrical portion 52 is in contact from the outer side in the radial direction and the image-side lens portion 5b (facing portion) that faces the object-side cylindrical portion 52 with a gap therebetween in the radial direction. Therefore, when the second cylindrical portion 50 of the second lens barrel member 22 is press-fitted into the inner side of the annular protrusion 26 of the first lens barrel member 21, it is possible to prevent or suppress the stress generated in the second cylindrical portion 50 from being transmitted to the second lens 5 located on the inner side in the radial direction of the object-side cylindrical portion 52. Therefore, it is possible to prevent or suppress the occurrence of distortion in the second lens 5.

Then, the flange portion 51 of the second lens barrel member 22 abuts the surface on the image side X1 of the annular protrusion 26 of the first lens barrel member 21, and the first welding surface 39 and the second welding surface 64 are welded to each other. Ultrasonic welding or laser welding can be used for the welding. During welding, the first reference surface 38 of the annular protrusion 26 of the first lens barrel member 21 and the second reference surface 63 of the flange portion 51 of the second lens barrel member 22 are brought into close contact with each other while melting the welding substitute projection 67 provided on the flange portion 51. Thus, the first reference surface 38 of the annular protrusion 26 is an optical axis direction positioning portion to position the second lens barrel member 22 in the optical axis direction X.

Here, when the second lens barrel member 22 is fixed to the first lens barrel member 21, the first lens 2 and the second lens 5 are not in contact with each other. In addition, the second lens barrel member 22 holding the lens group 4 is separated from the first lens 2 to the image side X1.

### Operation and Effect

According to this example, the first lens 2 is held by the first lens barrel member 21, and the lens group 4 located on the image side X1 of the first lens 2 is held by the second lens barrel member 22. In addition, the second lens barrel member 22 holding the lens group 4 is separated from the first lens 2 to the image side X1. Therefore, the second lens barrel member 22 is not involved in holding the first lens 2. Therefore, when the lens unit 1 is manufactured, holding the first lens 2 in the first lens barrel member 21 and holding the lens group 4 in the second lens barrel member 22 can be separately performed.

Here, in a case where holding the first lens 2 in the first lens barrel member 21 and holding the lens group 4 in the second lens barrel member 22 can be separately performed, when a plurality of variations having different shapes of the first lens barrel member 21 is developed as the lens unit 1, the first unit including the first lens 2 and the second lens barrel member 22 holding the first lens 2 can be manufactured for each variation, and the second unit including the lens group 4 and the second lens barrel member 22 holding the lens group 4 can be manufactured as a common component which is not influenced by the variation. In this way, it is possible to flexibly cope with a case where the mass production quantity for each variation of the lens unit 1 is changed.

Further, the inner-peripheral side end surface 35 facing the inner side in the radial direction in the annular protrusion 26 of the first lens barrel member 21 includes the plurality of projections 36. The plurality of projections 36 is a radial direction positioning portion that positions the second lens barrel member 22 in the radial direction. Further, the end surface of the annular protrusion 26 of the first lens barrel member 21 on the image side X1 includes the first reference surface 38 that abuts the second reference surface 63 provided in the flange portion 51 of the second lens barrel member 22. The first reference surface 38 is an optical axis direction positioning portion that positions the second lens barrel member 22 in the optical axis direction X. Thus, the second lens barrel member 22 is fixed to the first lens barrel member 21 with high positional accuracy. Therefore, even when the lens barrel 3 includes two members, i.e., the first lens barrel member 21 that holds the first lens 2 and the second lens barrel member 22 that holds the lens group 4, it is possible to prevent or suppress a decrease in the positional accuracy between the first lens 2 and the lens group 4.

Further, in this example, the first lens barrel member 21 is made of crystalline resin, and the second lens barrel member 22 is made of amorphous resin. Here, as compared with the amorphous resin, the crystalline resin is superior to the amorphous resin. Further, the amorphous resin is superior to the crystalline resin in hygroscopicity. Therefore, when the lens unit 1 is mounted on an in-vehicle imaging apparatus or an imaging apparatus installed outdoors, it is possible to suppress the aged deterioration of the first lens barrel member 21 which is easily exposed to external light. In addition, since the hygroscopicity of the second lens barrel member 22 is desirable, in a case where moisture is present in the space located closer to the image side X1 than the first lens 2 on the inner peripheral side of the first lens barrel member 21, the moisture can be absorbed by the second lens barrel member 22. Therefore, fogging of the image-side surface of the first lens 2 and the lenses 5 to 8 constituting the lens group 4 can be prevented or suppressed.

The first lens barrel member 21 and the second lens barrel member 22 may be fixed to each other with an adhesive. Specifically, the first lens barrel member 21 and the second lens barrel member 22 can be fixed to each other by an adhesive layer interposed between the flange portion 51 of the second lens barrel member 22 and the surface of the annular protrusion 26 of the first lens barrel member 21 on the image side X1. In this case, the welding substitute projection 67 of the flange portion 51 is omitted. Also in this case, the first reference surface 38 provided in the annular protrusion 26 of the first lens barrel member 21 can be an optical axis direction positioning portion that positions the second lens barrel member 22 in the optical axis direction X.

### Modification

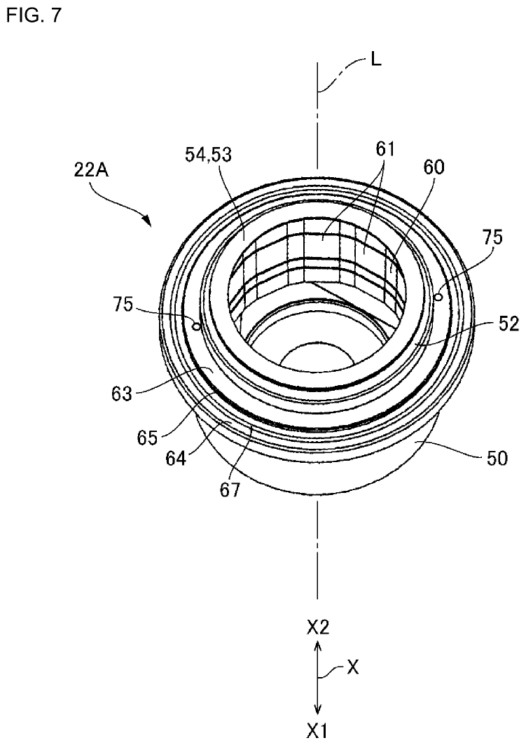

The second lens barrel member 22 may include a through-hole 75 penetrating in the optical axis direction X in the flange portion 51. FIG. 7 is an explanatory diagram of a second lens barrel member 22A according to a modification in which the flange portion 51 includes the through-hole 75. In this case, as illustrated by an imaginary line in FIG. 6, the through-hole 75 is provided at a position communicating with the gap 60 between the plurality of projections 36 provided on the inner-peripheral side end surface 35 of the annular protrusion 26 in the optical axis direction X when the object-side cylindrical portion 52 of the second lens barrel member 22A is press-fitted into the inner peripheral side of the annular protrusion 26 of the first lens barrel member 21.

Accordingly, the through-hole 75 communicates with a space S between the first lens 2 and the lens group 4 (the second lens 5) in the optical axis direction X via the gap 60 between the plurality of projections 36 provided on the inner-peripheral side end surface 35 of the annular protrusion 26. In this way, when moisture is present in the space S between the first lens 2 and the second lens 5, the moisture can be released to the outside via the through-hole 75. Therefore, fogging of the first lens 2 or the second lens 5 can be prevented or suppressed. It is desirable that the through-holes 75 be provided at two positions separated by 180° around the optical axis L.

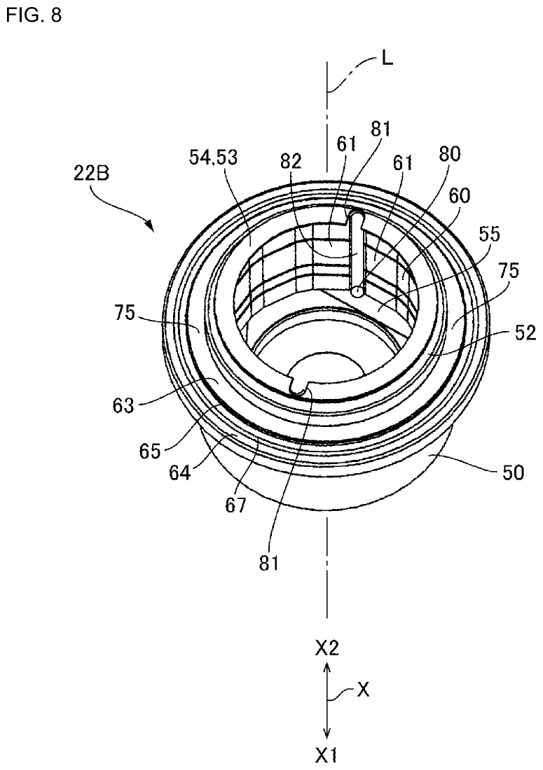

In addition, a second lens barrel member 22B may include a through-hole 80 penetrating the support portion 55 in the optical axis direction X. FIG. 8 is a perspective view of the second lens barrel member 22B in a case where the support portion 55 includes the through-hole 80. In this case, the second abutting portion 54 located at the end of the second cylindrical portion 50 on the object side X2 includes a cutout 81 in a part in the circumferential direction. Further, the through-hole 80 is provided at a position overlapping with the cutout 81 when viewed from the optical axis direction X. Further, a communication groove 82 extending in the optical axis direction X and allowing the cutout 81 and the through-hole 80 to communicate with each other is provided between the second abutting portion 54 and the support portion 55 on the inner peripheral surface 60 of the second cylindrical portion 50. Accordingly, the through-hole 80 communicates with the space S between the first lens 2 and the lens group 4 (the second lens 5) in the optical axis direction X via the communication groove 82 and the cutout 81. In this way, when moisture is present in the space S between the first lens 2 and the second lens 5, the moisture can be released to the outside via the through-hole 80. Therefore, fogging of the first lens 2 or the second lens 5 can be prevented or suppressed. In this example, two sets of the cutout 81, the communication groove 82, and the through-hole 80 are provided at positions separated by 180° around the optical axis L.

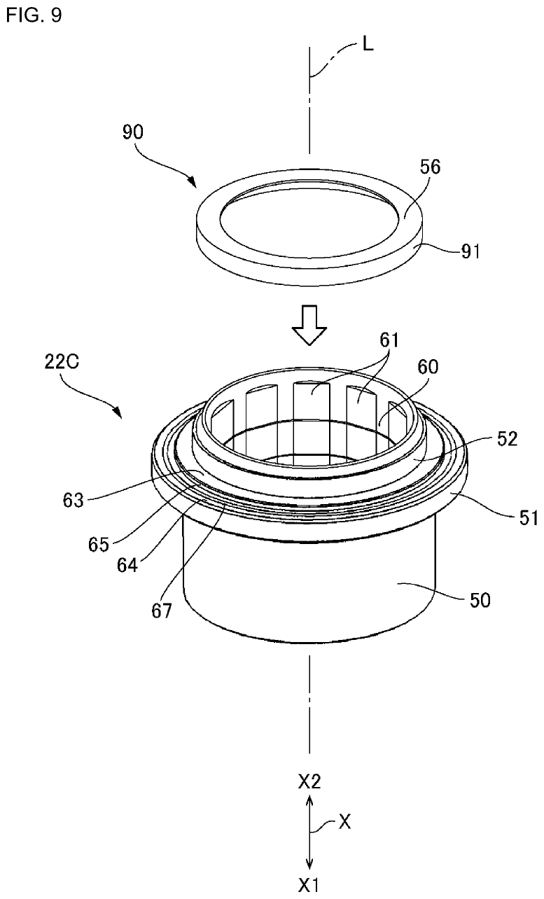

Further, instead of the second abutting portion 54 forming the holding mechanism 53 of the second lens barrel member 22, an annular retainer 90 may be used at the end portion of the second cylindrical portion 50 on the object side X2. FIG. 9 is an explanatory diagram of a case where the retainer 90 is attached to a second lens barrel member 22C that does not include the second abutting portion 54. In this case, the retainer 90 includes a peripheral wall portion 91 located on the outer peripheral side of the end portion of the second cylindrical portion 50 on the object side X2 and the second abutting portion 54 (abutting portion) that extends from the end of the peripheral wall portion 91 on the object side X2 to the inner peripheral side and abuts the second lens 5 from the object side X2. The support surface 31a of the first lens barrel member 21 is located closer to the image side X1 than the second abutting portion 54 of the retainer 90. In this way, the lens group 4 can be held from both sides in the optical axis direction X by the second abutting portion 54 of the retainer 90 and the annular support portion 55.

1. A lens unit comprising:
a first lens barrel member that holds a first lens; and
a second lens barrel member that holds, on an inner peripheral side of the first lens barrel member, a lens group located on an image side of the first lens,
wherein the first lens barrel member includes a first cylindrical portion including a holding portion that holds the first lens from an outer peripheral side and an annular protrusion that protrudes from the image side of the holding portion to an inner peripheral side in the first cylindrical portion,
the second lens barrel member includes a second cylindrical portion that surrounds the lens group from an outer peripheral side and a flange portion that protrudes from the second cylindrical portion to an outer peripheral side, and is separated from the first lens to the image side,
the annular protrusion includes a first lens support portion that includes an annular support surface that supports the first lens from the image side, a radial direction positioning portion that is in contact with the second cylindrical portion from an outer side in a radial direction and positions the second lens barrel member in the radial direction, and an optical axis direction positioning portion that is in contact with the flange portion from an object side and positions the second cylindrical portion in an optical axis direction, and
the flange portion is fixed to the annular protrusion.

2. The lens unit according to claim 1, wherein the second lens barrel member includes an abutting portion that is bent from an end of the second cylindrical portion on the object side to an inner peripheral side and abuts a second lens located closest to the object side in the lens group from the object side, and an annular support portion that protrudes to an inner side in a radial direction from the second cylindrical portion and supports the lens group from the image side.

3. The lens unit according to claim 1, comprising an annular retainer attached to an end portion of the second cylindrical portion on the object side,
wherein the retainer includes a peripheral wall portion fixed to an outer peripheral side of the end portion of the second cylindrical portion on the object side and an abutting portion that extends from an end of the peripheral wall portion on the object side to an inner peripheral side and abuts a second lens located closest to the object side in the lens group from the object side, and
the second lens barrel member includes an annular support portion that protrudes to an inner side in a radial direction from the second cylindrical portion and supports the lens group from the image side.

4. The lens unit according to claim 1,
wherein the flange portion protrudes from a middle of the second cylindrical portion in the optical axis direction,
an inner-peripheral side end surface of the annular protrusion is provided with a plurality of projections arranged in a circumferential direction,
the plurality of projections is in contact with an object-side cylindrical portion located closer to the object side than the flange portion in the second cylindrical portion from an outer side in the radial direction, and
the plurality of projections is the radial direction positioning portion.

5. The lens unit according to claim 4, wherein
the plurality of projections is provided on the object side of the inner-peripheral side end surface,
the lens group includes a lens located on an inner side of the object-side cylindrical portion in the radial direction,
the lens includes, in the stated order from the object side to the image side, a contact portion with which the object-side cylindrical portion is in contact from an outer side in the radial direction and a facing portion that faces the object-side cylindrical portion with a gap therebetween in the radial direction, and
when viewed from a direction orthogonal to the optical axis, the plurality of projections and the facing portion of the lens overlap each other.

6. The lens unit according to claim 1, wherein
the annular protrusion includes an annular groove recessed to the image side on an outer peripheral side of the support surface,
an annular elastic member is inserted into the annular groove, and
the elastic member seals a space between the first lens and the annular protrusion in a state of being compressed in the optical axis direction.

7. The lens unit according to claim 1, wherein
the first lens barrel member and the second lens barrel member are made of resin, and
the annular protrusion and the flange portion are welded to each other.

8. The lens unit according to claim 7, wherein
in a state before the annular protrusion and the flange portion are welded to each other,
the annular protrusion includes, on a surface facing the image side, a first reference surface perpendicular to the optical axis and a first welding surface parallel to the first reference surface and provided at a position shifted from the first reference surface to an image side X1,
the flange portion includes, on a surface facing the object side, a second reference surface perpendicular to the optical axis and a second welding surface parallel to the second reference surface and provided at a position shifted from the second reference surface to the other side in the optical axis direction,
one of the first welding surface and the second welding surface is provided with a welding substitute projection that projects in the optical axis direction,
in a state where the annular protrusion and the flange portion are welded to each other,
the first reference surface and the second reference surface are in surface contact with each other, and
the first welding surface and the second welding surface are welded to each other.

9. The lens unit according to claim 1, wherein
the first lens barrel member is made of crystalline resin, and
the second lens barrel member is made of amorphous resin.

10. The lens unit according to claim 2,
wherein the flange portion protrudes from a middle of the second cylindrical portion in the optical axis direction,
an inner-peripheral side end surface of the annular protrusion is provided with a plurality of projections arranged in a circumferential direction,
the plurality of projections is in contact with an object-side cylindrical portion located closer to the object side than the flange portion in the second cylindrical portion from an outer side in the radial direction, and
the plurality of projections is the radial direction positioning portion.

11. The lens unit according to claim 10, wherein
the plurality of projections is provided on the object side of the inner-peripheral side end surface,
the lens group includes a lens located on an inner side of the object-side cylindrical portion in the radial direction,
the lens includes, in the stated order from the object side to the image side, a contact portion with which the object-side cylindrical portion is in contact from an outer side in the radial direction and a facing portion that faces the object-side cylindrical portion with a gap therebetween in the radial direction, and
when viewed from a direction orthogonal to the optical axis, the plurality of projections and the facing portion of the lens overlap each other.

12. The lens unit according to claim 11, wherein
the first lens barrel member and the second lens barrel member are made of resin, and
the annular protrusion and the flange portion are welded to each other.

13. The lens unit according to claim 13, wherein
in a state before the annular protrusion and the flange portion are welded to each other,
the annular protrusion includes, on a surface facing the image side, a first reference surface perpendicular to the optical axis and a first welding surface parallel to the first reference surface and provided at a position shifted from the first reference surface to an image side X1,
the flange portion includes, on a surface facing the object side, a second reference surface perpendicular to the optical axis and a second welding surface parallel to the second reference surface and provided at a position shifted from the second reference surface to the other side in the optical axis direction,
one of the first welding surface and the second welding surface is provided with a welding substitute projection that projects in the optical axis direction,
in a state where the annular protrusion and the flange portion are welded to each other,
the first reference surface and the second reference surface are in surface contact with each other, and
the first welding surface and the second welding surface are welded to each other.

14. The lens unit according to claim 13, wherein
the first lens barrel member is made of crystalline resin, and
the second lens barrel member is made of amorphous resin.

15. The lens unit according to claim 2, wherein
the first lens barrel member and the second lens barrel member are made of resin, and
the annular protrusion and the flange portion are welded to each other.

16. The lens unit according to claim 15, wherein
in a state before the annular protrusion and the flange portion are welded to each other,
the annular protrusion includes, on a surface facing the image side, a first reference surface perpendicular to the optical axis and a first welding surface parallel to the first reference surface and provided at a position shifted from the first reference surface to an image side X1,
the flange portion includes, on a surface facing the object side, a second reference surface perpendicular to the optical axis and a second welding surface parallel to the second reference surface and provided at a position shifted from the second reference surface to the other side in the optical axis direction,
one of the first welding surface and the second welding surface is provided with a welding substitute projection that projects in the optical axis direction,
in a state where the annular protrusion and the flange portion are welded to each other,
the first reference surface and the second reference surface are in surface contact with each other, and
the first welding surface and the second welding surface are welded to each other.

17. The lens unit according to claim 2, wherein
the first lens barrel member is made of crystalline resin, and
the second lens barrel member is made of amorphous resin.
